(19) United States
(12) Patent Application Publication
(10) Pub. No.: US 2023/0018844 A1
(43) Pub. Date: Jan. 19, 2023

(54) Lateral Trailer Suspension Support Device

(71) Applicant: R. Royce Henry, El Cajon, CA (US)

(72) Inventor: R. Royce Henry, El Cajon, CA (US)

(21) Appl. No.: 17/661,310

(22) Filed: Apr. 29, 2022

Related U.S. Application Data
(63) Continuation-in-part of application No. 17/305,816, filed on Jul. 15, 2021, now abandoned.

(51) Int. Cl. B60G 9/00; B60G 5/02

(52) U.S. Cl. CPC B60G 9/003; B60G 5/02; B60G 2300/04; B60G 2200/341; B60G 2200/314

(57) ABSTRACT

The Lateral Trailer Suspension Support Device system is a suspension support that locks the axles of a trailer into the frame of the trailer, similar to a track bar on a truck. It is a lateral trailer suspension support device for reducing lateral loading of a trailer body having a wheeled axle comprising a frame rail connectively attached to said trailer body, a rigid member having a frame connection end having a first flexible joint connectively attached to said frame rail and an axle connection end having a second flexible joint connectively attached to said wheeled axle. It prevents and decreases lateral loading on all types of trailers. It can be used on single, tandem, and triple axle trailers.

### CROSS REFERENCE TO RELATED APPLICATIONS

This continuation in part application claims the benefit under 35 U.S.C. § 119(e) of U.S. patent application Ser. No. 17/305,816, filed Jul. 7, 2021 the disclosure of which is incorporated by reference herein.

### TECHNICAL FIELD OF THE INVENTION

This invention relates generally to a Lateral Trailer Suspension Support Device in the form of a rigid member attached between the frame of a trailer and its axle for the purpose of preventing lateral loading on all types of trailers while in use.

### BACKGROUND

Laterally loading on axles is a common problem for trailers of all types. There are track bars available for trucks that help prevent lateral loading of the frame/body of the truck over its axles. However, there exists no such solution to prevent lateral loading for existing trailers.

In light of the foregoing prior art, there is a need for a lateral trailer suspension support device that locks the axles into the frame to prevent lateral loading on all types of trailers.

### BRIEF SUMMARY OF THE INVENTION

According to a first aspect of the invention there is a lateral trailer suspension support device for operable installation on an existing trailer having a body or frame, comprising a rail operable to be connectively attached to said trailer's body or frame along a longitudinal portion of said trailer's body or frame, and at least one rigid member, having a first end and a second end, wherein said first end of said rigid member is connected to said rail by a first joint means, and wherein said second end of said rigid member is operable to be connected to an axle of said trailer by a second joint means.

According to a second aspect of the invention there is a lateral trailer suspension support device for operable installation on an existing trailer having a body or frame, wherein said first joint means comprises a U-shaped receiver having a straight-pin hinge, wherein said U-shaped receiver is connectively attached to said rail, and wherein said first end of said rigid member further comprises said straight pin hinge positioned within said U-shaped receiver.

According to a third aspect of the invention there is a lateral trailer suspension support device for operable installation on an existing trailer having a body or frame, wherein said first joint means comprises a universal socket joint connectively attached to said first end of said rigid member and connecting said first end of said rigid member to said rail.

According to a fourth aspect of the invention there is a lateral trailer suspension support device for operable installation on an existing trailer having a body or frame, wherein said first joint means comprises a heim joint connectively attached to said first end of said rigid member and connecting said first end of said rigid member to said rail.

According to a fifth aspect of the invention there is a lateral trailer suspension support device for operable installation on an existing trailer having a body or frame, wherein said second joint means comprises a U-shaped receiver having a straight-pin hinge, wherein said U-shaped receiver is operable to be connected to said-axle, and wherein the second end of said rigid member comprises said straight-pin hinge positioned within said U-shaped receiver, and/or wherein said U-shaped receiver additionally comprises a saddle shaped connection brace.

According to a sixth aspect of the invention there is a lateral trailer suspension support device for operable installation on an existing trailer having a body or frame, wherein said second joint means comprises a universal socket joint operable to be connected to axle and connecting said second end of said rigid member to said axle, and/or wherein said U-shaped receiver additionally comprises a saddle shaped connection brace.

According to a seventh aspect of the invention there is a lateral trailer suspension support device for operable installation on an existing trailer having a body or frame, wherein said second joint means comprises a heim joint operable to be connected to said axle and connecting said second end of said rigid member to said axle, and/or wherein said U-shaped receiver additionally comprises a saddle shaped connection brace.

According to an eighth aspect of the invention there is a method of reducing lateral loading of an existing trailer body or frame on at least one axle of said trailer comprising the installation of a lateral trailer suspension support device between said trailer body or frame and said axle comprising attaching a rail of said device to a longitudinal portion of said body of said trailer, attaching a first end of a rigid member of said device to said rail by a first joint means, and attaching a second end of said rigid member of said device to said axle of said trailer by a second joint means.

According to a ninth aspect of the invention there is a method of reducing lateral loading of a trailer body or frame on at least one axle of said trailer wherein said first joint means comprises a U-shaped receiver having a straight-pin hinge, wherein said U-shaped receiver is connectively attached to said rail, and wherein said first end of said rigid member comprises said straight-pin hinge positioned within said U-shaped receiver.

According to a tenth aspect of the invention there is a method of reducing lateral loading of a trailer body or frame on at least one axle of said trailer wherein said first joint means comprises a universal socket joint connectively attached to said first end of said rigid member and connecting said first end of said rigid member to said rail.

According to an eleventh aspect of the invention there is a method of reducing lateral loading of a trailer body or frame on at least one axle of said trailer wherein said first joint means comprises a heim joint connectively attached to said first end of said rigid member and connecting said first end of said rigid member to said rail, and/or wherein said first joint means is a structure comprising at least one of the following: U-joint, universal socket joint, heim joint, or any combination thereof.

According to a twelfth aspect of the invention there is a method of reducing lateral loading of a trailer body or frame on at least one axle of said trailer wherein said second joint means comprises a U-shaped receiver having a straight pin hinge, and/or wherein said U-shaped receiver is operable to be connected to said axle, and wherein the second end of said rigid member comprises said straight-pin hinge positioned within said U-shaped receiver, wherein said U-shaped receiver additionally comprises a saddle-shaped connection brace and wherein method further comprises connecting said U-shaped receiver to said axle by a saddle-shaped connection brace.

According to a thirteenth aspect of the invention there is a method of reducing lateral loading of a trailer body or frame on at least one axle of said trailer, wherein said second joint means comprises a universal socket joint operable to be connected to said axle, and connecting said second end of said rigid member to said axle, and/or wherein said universal socket joint additionally comprises a saddle-shaped connection brace and wherein method further comprises connecting said universal socket joint to said axle by a saddle-shaped connection brace.

According to a fourteenth aspect of the invention there is a method of reducing lateral loading of a trailer body or frame on at least one axle of said trailer wherein said second joint means comprises a heim joint operable to be connected to said axle, and connecting said second end of said rigid member to said axle, and/or wherein said heim joint additionally comprises a saddle-shaped connection brace and wherein method further comprises connecting said universal heim joint to said axle by a saddle-shaped connection brace.

According to a fifteenth aspect of the invention there is a lateral trailer suspension support device for operable installation on an existing trailer having a body or frame, wherein said first joint means is a structure comprising at least one of the following: direct welding, bolting, U-joint, universal socket joint, heim joint, or any combination thereof.

According to a sixteenth aspect of the invention there is a lateral trailer suspension support device for operable installation on an existing trailer having a body or frame, wherein said second joint means is a structure comprising at least one of the following: direct welding, bolting, U-joint, universal socket joint, heim joint, or any combination thereof, and/or wherein said second joint means additionally comprises a saddle shaped connection brace.

According to a seventeenth aspect of the invention there is a method of reducing lateral loading of a trailer body or frame on at least one axle of said trailer wherein said second joint means is a structure comprising at least one of the following: U-joint, universal socket joint, heim joint, or any combination thereof, and/or wherein said second joint means additionally comprises a saddle-shaped connection brace and wherein method further comprises connecting said second joint means to said axle by a saddle-shaped connection brace.

An advantage of the lateral trailer suspension support device is it provides additional rigidity between a frame and an axle of a trailer to resist lateral motion or movement between the frame and axle of a trailer during motion or movement of the trailer. An advantage of the lateral trailer suspension support device is it alleviates the very common problem of lateral loading on trailers. Lateral loading causes breaks in suspension components of trailers such as, but not limited to the following: broken hangers, leaf springs, cracked frames, bent frames, and other axle and frame connected elements.

The invention will now be described, by way of example only, with reference to the accompanying drawings in which:

### BRIEF DESCRIPTION OF THE DRAWINGS

FIG. 1 is a perspective view of an implementation of the lateral trailer suspension support device, wherein the device shown to be installed between a trailer frame and the trailer's wheeled axle, as the device being used by according to the invention;

FIG. 2 is a perspective view of an implementation of the lateral suspension support device according to the invention;

FIG. 3 is a rear view of an implementation of the lateral trailer suspension support device, wherein the device shown to be installed between a trailer frame and the trailer's wheeled axle as the device being used according to the invention;

FIG. 4 is a rear view of an implementation of the lateral trailer suspension support device, wherein the device shown to be installed between a frame and the suspension system of the trailer's wheeled axle as the device being used according to the invention;

FIG. 5 shows a perspective view of an implementation of the lateral suspension support device according to the invention, wherein the first flexible joint means and second flexible joint means are universal socket joints; and

FIG. 6 shows a perspective view of an implementation of the lateral suspension support device according to the invention, wherein the first flexible joint means and second flexible joint means are hem joints.

It should be noted that particular structure of the universal socket joint and the hem joint may vary from what depicted on the figures and includes all structural variations known to the person of ordinary skill in the art.

It's to be noted that all figures represent only some of the possible implementations of the devise. Furthermore, the first and the second flexible joint means of the single implementation do not not necessarily include identical joint means. In other words, the first and the second joint means can be mixed-and-matched with is a single embodiment in any combination. Additionally, the second joint means may not necessarily include a saddle brace and may include an alternative structure able to perform the desired function, i.e. attaching the second end of the rigid member connected to the second flexible joint means to the axle of the trailer.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Index of Labelled Features in Figures. Features are listed in numeric order by Figure in numeric order.

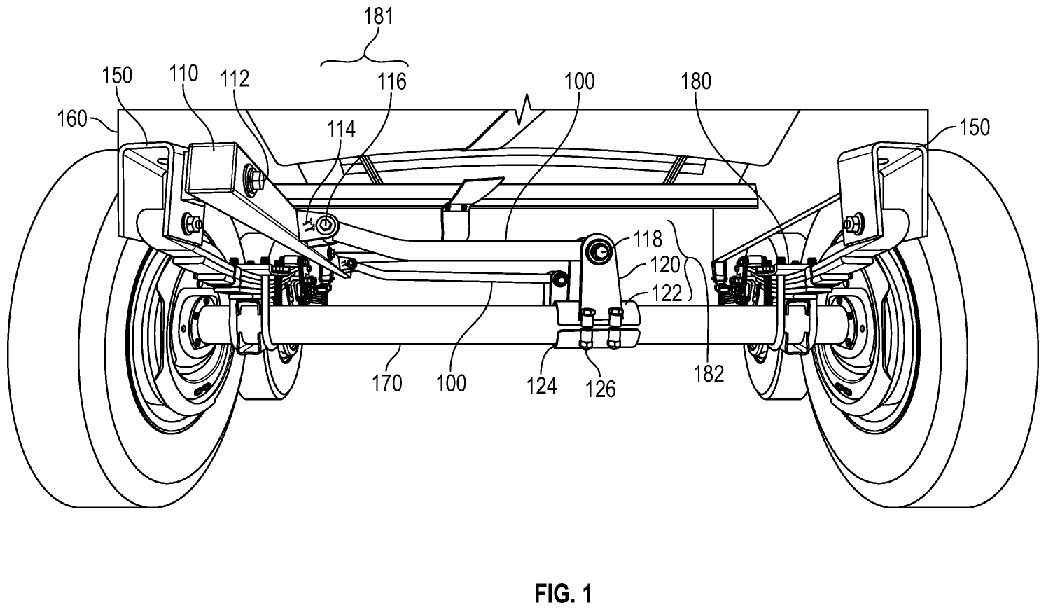

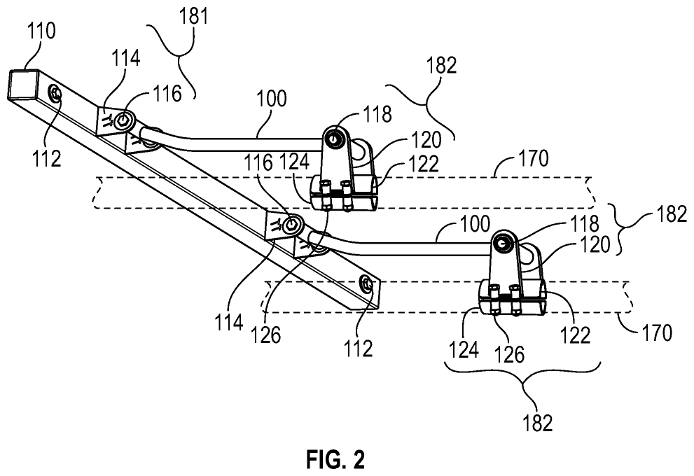

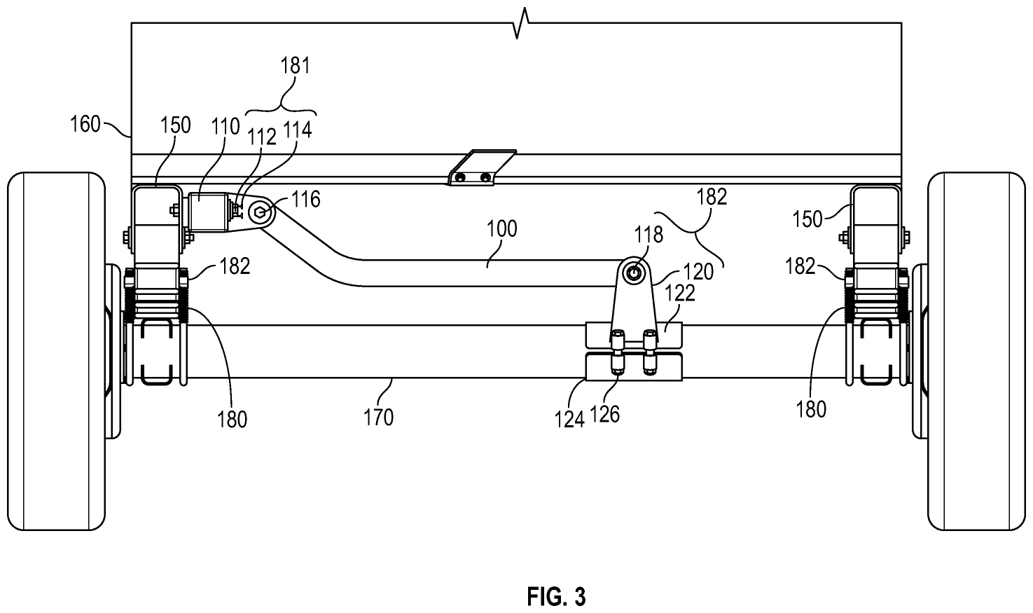

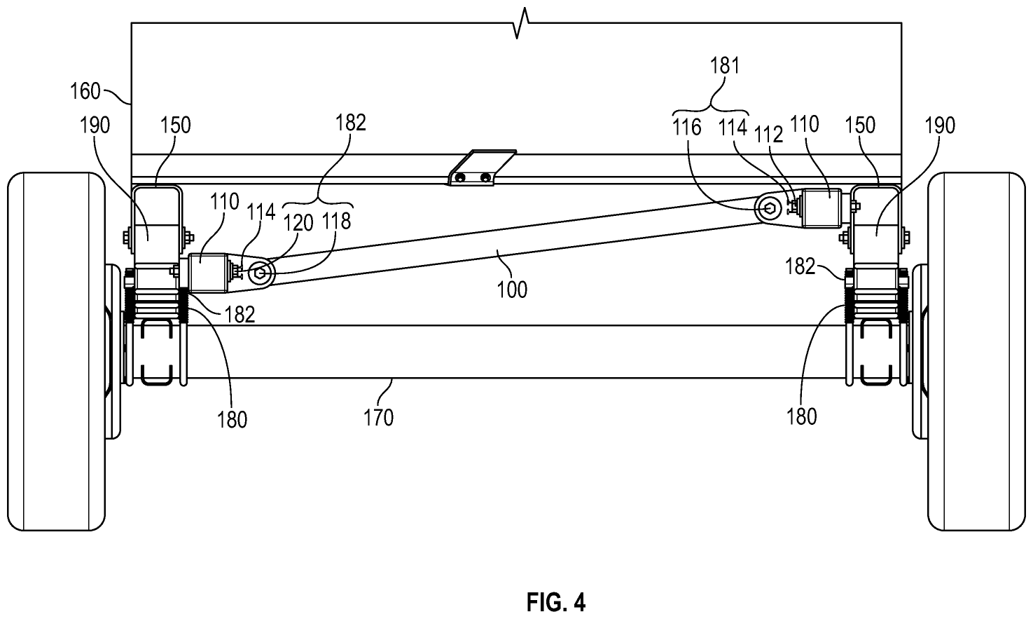

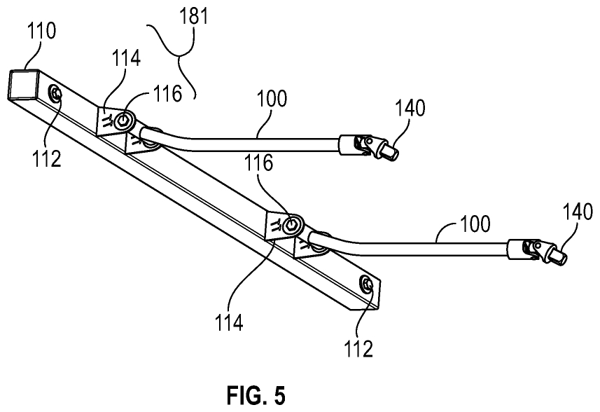

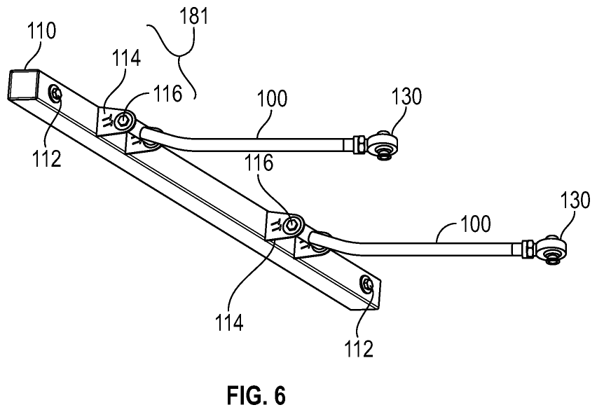

Referring to the Figures, there is shown in FIGS. 1, 2, 3, 4, 5, and 6 the following features:
Element 100 which is a rigid member.
Element 110 which is a frame rail.
Element 112 which is an attachment bolt.
Element 114 which is first U-shaped receiver.
Element 116 which is a first straight-pin hinge connection with threaded ends having a washer and threaded bolt.
Element 118 which is a second straight-pin hinge connection with threaded ends having a washer and threaded bolt.
Element 120 which is a second U-shaped receiver.
Element 122 which is a top-half saddle connection for an axle.
Element 124 which is a bottom-half saddle connection for an axle.
Element 126 which is a saddle connection threaded bolt for securing together a top-half saddle connection and a bottom-half saddle connection.
Element 130 which is a heim joint.
Element 140 which is a universal socket joint.
Element 150 which is a frame member.
Element 160 which is a trailer frame/body.
Element 170 which is a trailer axle.
Element 180 which is an axle suspension connection.
Element 181 which is an embodiment of a first joint means.
Element 182 which is an embodiment of a second joint means.

The device/apparatus of the present invention is to be installed connectively attaching said device between an existing, or a new trailer body/frame member and an axle of a trailer to serve as a rigid or semi-rigid structure between the frame and the axle of a trailer. Connecting the frame and axle of a trailer with a rigid or semi-rigid structure serves to provide an added brace to reinforce the connection between the frame and the axle of the trailer providing added resistance to a potential lateral motion or separation between the frame and axle while the trailer is in motion.

Connectively attaching a rigid member part of the lateral trailer suspension support device to a trailer's frame may be accomplished, for example, by directly welding, bolting the first end of the rigid member to the trailer's body, trailer's frame, trailer's frame member. Alternatively, the rigid member of the device may be first affixed to the rail of the device, for example by direct welding, or as being connected to the rail through the first flexible joint means that are affixed to the rail, where rail in its terms is operable to be affixed to the trailer body, frame and/or member along longitudinal portion of the trailer's body by any conventional means (i.e. welding, bolting etc.). Alternatively, the rigid member may be connected directly to a U-joint or hem joint, universal socket joint and through similar structures that is/are welded or bolted or otherwise attached directly to the frame or member of the trailer. Other methods of attaching a rigid member part of the device or rail of the device to the trailer may be evident to the person of ordinary skill in the art, wherein the methods could be used and included herein alone or in any combination.

The “first flexible joint means” is a structure that is used to attach/connect the rigid member of the device to the rail of the device comprising of from the U-joint, universal socket joint, hem joint, or functionally similar structure that is capable of flexibly/pivotally/hingedly connecting the rigid member of the device to the rail of the device, wherein said structures may be used alone or in any combination.

Connectively attaching a rigid member of the device to a trailer's axle may be accomplished, for example, by any of the following: direct welding of the second end of the rigid member to the axle, connection of the rigid member to an axle's frame, connection of the rigid member to a U-joint that is welded or bolted to the axle, and/or by connecting the rigid member to a heim joint or universal socket joint that is connected to the axle. The rigid member may be connected to the trailer's axle through the second flexible joint means, wherein second flexible joint means component(s) are operable to enable said connection to said axle. Other methods of attaching a rigid member part of the device to the axle of the trailer may be evident to the person of ordinary skill in the art, wherein the methods could be used and included herein alone or in any combination.

The “second flexible joint means” is a structure that is used to attach/connect the rigid member of the device to the axle of the trailer comprising U-joint, universal socket joint, hem joint or functionally similar structure that is capable of flexibly/pivotally/hingedly connecting the rigid member of the device to the axle of the trailers, wherein said structures may be used alone or in any combination. In some implementations, the “second flexible joint means” is additionally comprising a saddle-shaped connection brace or another structure including necessary elements (i.e. screws, bolts etc.) that enables and is operable to secure the “second flexible

In one preferred embodiment, a lateral trailer suspension support device for reducing lateral loading of a trailer body on a wheeled axle(s) consisting of a rail operable to be connectively attached to the trailer's body along its longitudinal portion, at least one rigid member, wherein the rigid member having a first end and a second end, wherein the first end is connected to the rail by first flexible joint means and wherein the second end is operable to be connected to the wheeled axle of the trailer by a second flexible joint means additionally comprising a saddle-shaped connection brace.

In another preferred embodiment, the lateral suspension support device includes two rigid members, wherein each rigid member has a first end and a second end, wherein the first ends of the rigid members are connected to the rail by the first flexible joint means, and wherein the second ends of the rigid members are connected to wheeled axels of the trailer by the the second flexible joint means comprising a the saddle-shaped connection braces.

In some implementations a permanent (non-flexible) connection (i.e. welded, bolted) may be used in place of at least one first and/or second flexible joint means and/or saddle-shaped brace(s).

In some implementations the lateral trailer suspension support device is pre-assembled for the purposes of installation by a user and consists of the following parts: the rail, at least the one first flexible joint means, the rigid member(s), at least the one second joint means that comprising the saddle connection(s). In some implementations, the saddle-shaped connection braced of the second joint means may be replaced by another feature capable of providing a secure attachment of the second joint means to the axle of the trailer.

In an embodiment, a lateral trailer suspension support device includes first flexible joint means comprising a U-shaped receiver having a straight-pin hinge, wherein the U-shaped receiver is connectively attached to the rail, and wherein the first end of the device's rigid member comprises the straight-pin hinge positioned within a U-shape receiver.

In an another embodiment, a lateral trailer suspension support device-includes a first flexible joint means comprising a universal socket joint connectively attached to the first end of the rigid member and connecting said first end of the rigid member to the rail.

In another embodiment, a lateral trailer suspension support device includes a first flexible joint means comprising a heim joint connectively attached to the first end of the rigid member and connecting said first end of the rigid member to the rail.

In an embodiment, a lateral trailer suspension support device includes a second flexible joint means comprising a U-shaped receiver having a straight-pin hinge, wherein the U-shaped receiver is operable to be connected to the wheeled axle via a saddle brace, and wherein the second end of the rigid member comprises the second straight-pin hinge positioned within the U-shaped receiver.

In another embodiment, a lateral trailer suspension support device includes a second flexible joint means comprising a universal socket joint operable to be connected to a wheeled axle via a saddle brace or alternative means, and connecting the second end of the rigid member to the trailer's axle.

In another embodiment, a lateral trailer suspension support device includes a second flexible joint means comprising a heim joint operable to be connected to a wheeled axle via a saddle brace or alternative means, and connecting the second end of the rigid member to the trailer's axle.

In a preferred embodiment, there is a method of reducing lateral loading of a trailer body on a wheeled axle(s) comprising the installation of the lateral trailer suspension support device comprising: attaching the rail of the lateral suspension support device to the trailer body or to the trailer frame member(s) along a longitudinal portion of said trailer's body; attaching a first end of a rigid member of the device to the rail by the first joint means; attaching a second second end of the rigid member of the device to said axle(s) of said trailer by a second joint means; attaching the saddle brace(s) of the second flexible joint means the device to the wheeled axle(s) of the trailer.

In another embodiment the second flexible joint means can be affixed to the trailer's axle by saddle braces or any alternative methods allowing for secure attachment of the second joint means to the axle(s).

In an alternate embodiment, there is a lateral trailer suspension support device wherein said device is a bolt-on version, that bolts into/onto the existing hangers or other parts of a trailer suspension system.

An advantage of the lateral trailer suspension support device is that it creates an additional rigid or semi-rigid connection between a frame and an axle of a trailer, thereby enabling a resistance to movement of the trailer's frame (body) in the lateral direction.

An advantage of the lateral trailer suspension support device is it alleviates a very common problem of lateral loading in trailers. Furthermore, the lateral trailer suspension support device can be used on single, tandem, triple, or multiple-axle trailers as it may have multiple rigid members each having first ends and second ends, wherein the first ends are connected to the rail by first flexible joints means and wherein the second ends are operable to be connected to the wheeled axles of the trailer by a second flexible joints means, that may include saddle-shaped connection braces.

In a preferred embodiment of the invention, there is a lateral trailer suspension support device for operable installation on a trailer having a body or frame, comprising a rail operable to be connectively attached to said trailer's body or frame along a longitudinal portion of said trailer's body or frame, and at least one rigid member, having a first end and a second end, wherein said first end of said rigid member is connected to said rail by a first joint means, and wherein said second end of said rigid member is operable to be connected to an axle of said trailer by a second joint means.

In an alternate embodiment of the invention, there is a lateral trailer suspension support device for operable installation on an existing trailer having a body or frame, wherein said first joint means comprises a U-shaped receiver having a straight-pin hinge, wherein said U-shaped receiver is connectively attached to said rail, and wherein said first end of said rigid member further comprises said straight pin hinge positioned within said U-shaped receiver.

In an alternate embodiment of the invention, there is a lateral trailer suspension support device for operable installation on an existing trailer having a body or frame, wherein said first joint means comprises a universal socket joint connectively attached to said first end of said rigid member and connecting said first end of said rigid member to said rail.

In an alternate embodiment of the invention, there is a lateral trailer suspension support device for operable installation on an existing trailer having a body or frame, wherein said first joint means comprises a heim joint connectively attached to said first end of said rigid member and connecting said first end of said rigid member to said rail.

In an alternate embodiment of the invention, there is a lateral trailer suspension support device for operable installation on an existing trailer having a body or frame, wherein said second joint means comprises a U-shaped receiver having a straight-pin hinge, wherein said U-shaped receiver is operable to be connected to said-axle, and wherein the second end of said rigid member comprises said straight-pin hinge positioned within said U-shaped receiver, and/or wherein said U-shaped receiver additionally comprises a saddle shaped connection brace.

In an alternate embodiment of the invention, there is a lateral trailer suspension support device for operable installation on an existing trailer having a body or frame, wherein said second joint means comprises a universal socket joint operable to be connected to axle and connecting said second end of said rigid member to said axle, and/or wherein said U-shaped receiver additionally comprises a saddle shaped connection brace.

In an alternate embodiment of the invention, there is a lateral trailer suspension support device for operable installation on an existing trailer having a body or frame, wherein said second joint means comprises a heim joint operable to be connected to said axle and connecting said second end of said rigid member to said axle, and/or wherein said U-shaped receiver additionally comprises a saddle shaped connection brace.

In a preferred embodiment of the invention, there is a method of reducing lateral loading of a trailer body or frame on at least one axle of said trailer comprising the installation of a lateral trailer suspension support device between said trailer body or frame and said axle comprising attaching a rail of said device to a longitudinal portion of said body of said trailer, attaching a first end of a rigid member of said device to said rail by a first joint means, and attaching a second end of said rigid member of said device to said axle of said trailer by a second joint means.

In an alternate embodiment of the invention, there is a method of reducing lateral loading of a trailer body or frame on at least one axle of said trailer wherein said first joint means comprises a U-shaped receiver having a straight-pin hinge, wherein said U-shaped receiver is connectively attached to said rail, and wherein said first end of said rigid member comprises said straight-pin hinge positioned within said U-shaped receiver.

In an alternate embodiment of the invention, there is a method of reducing lateral loading of a trailer body or frame on at least one axle of said trailer wherein said first joint means comprises a universal socket joint connectively attached to said first end of said rigid member and connecting said first end of said rigid member to said rail.

In an alternate embodiment of the invention, there is a method of reducing lateral loading of a trailer body or frame on at least one axle of said trailer wherein said first joint means comprises a heim joint connectively attached to said first end of said rigid member and connecting said first end of said rigid member to said rail, and/or wherein said first joint means is a structure comprising at least one of the following: U-joint, universal socket joint, heim joint, or any combination thereof.

In an alternate embodiment of the invention, there is a method of reducing lateral loading of a trailer body or frame on at least one axle of said trailer wherein said second joint means comprises a U-shaped receiver having a straight pin hinge, and/or wherein said U-shaped receiver is operable to be connected to said axle, and wherein the second end of said rigid member comprises said straight-pin hinge positioned within said U-shaped receiver, wherein said U-shaped receiver additionally comprises a saddle-shaped connection brace and wherein method further comprises connecting said U-shaped receiver to said axle by a saddle-shaped connection brace.

In an alternate embodiment of the invention, there is a method of reducing lateral loading of a trailer body or frame on at least one axle of said trailer, wherein said second joint means comprises a universal socket joint operable to be connected to said axle, and connecting said second end of said rigid member to said axle, and/or wherein said universal socket joint additionally comprises a saddle-shaped connection brace and wherein method further comprises connecting said universal socket joint to said axle by a saddle-shaped connection brace.

In an alternate embodiment of the invention, there is a method of reducing lateral loading of a trailer body or frame on at least one axle of said trailer wherein said second joint means comprises a heim joint operable to be connected to said axle, and connecting said second end of said rigid member to said axle, and/or wherein said heim joint additionally comprises a saddle-shaped connection brace and wherein method further comprises connecting said universal heim joint to said axle by a saddle-shaped connection brace.

In an alternate embodiment of the invention, there is a lateral trailer suspension support device for operable installation on an existing trailer having a body or frame, wherein said first joint means is a structure comprising at least one of the following: direct welding, bolting, U-joint, universal socket joint, heim joint, or any combination thereof.

In an alternate embodiment of the invention, there is a lateral trailer suspension support device for operable installation on an existing trailer having a body or frame, wherein said second joint means is a structure comprising at least one of the following: direct welding, bolting, U-joint, universal socket joint, heim joint, or any combination thereof, and/or wherein said second joint means additionally comprises a saddle shaped connection brace.

In an alternate embodiment of the invention, there is a method of reducing lateral loading of a trailer body or frame on at least one axle of said trailer wherein said second joint means is a structure comprising at least one of the following: U-joint, universal socket joint, heim joint, or any combination thereof, and/or wherein said second joint means additionally comprises a saddle-shaped connection brace and wherein method further comprises connecting said second joint means to said axle by a saddle-shaped connection brace.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A lateral trailer suspension support device for operable installation on an existing trailer having a body or frame, comprising
a rail operable to be connectively attached to said body or frame of said trailer along a longitudinal portion of said trailer's body or frame, and
at least one rigid member, having a first end and a second end, wherein said first end of said rigid member is connected to said rail by a first joint means, and wherein said second end of said rigid member is operable to be connected to an axle of said trailer by a second joint means.

2. The device of claim 1 wherein said first joint means comprises a U-shaped receiver having a straight-pin hinge, wherein said U-shaped receiver is connectively attached to said rail, and wherein said first end of said rigid member further comprises said straight pin hinge positioned within said U-shaped receiver.

3. The device of claim 1 wherein said first joint means comprises a universal socket joint connectively attached to said first end of said rigid member and connecting said first end of said rigid member to said rail.

4. The device of claim 1 wherein said first joint means comprises a heim joint connectively attached to said first end of said rigid member and connecting said first end of said rigid member to said rail.

5. The device of claim 1 wherein said second joint means comprises a U-shaped receiver having a straight-pin hinge, wherein said U-shaped receiver is operable to be connected to said-axle, and wherein the second end of said rigid member comprises said straight-pin hinge positioned within said U-shaped receiver.

6. The device of claim 1 wherein said second joint means comprises a universal socket joint operable to be connected to said axle and connecting said second end of said rigid member to said axle.

7. The device of claim 1 wherein said second joint means comprises a heim joint operable to be connected to said axle and connecting said second end of said rigid member to said axle.

8. A method of reducing lateral loading of an existing trailer body or frame on at least one axle of a trailer comprising the installation of a lateral trailer suspension support device between said trailer body or frame and said axle comprising
attaching a rail of said device to a longitudinal portion of said body of said trailer,
attaching a first end of a rigid member of said device to said rail by a first joint means, and
attaching a second end of said rigid member of said device to said axle of said trailer by a second joint means.

9. The method of claim 8 wherein said first joint means comprises a U-shaped receiver having a straight-pin hinge, wherein said U-shaped receiver is connectively attached to said rail, and wherein said first end of said rigid member comprises said straight-pin hinge positioned within said U-shaped receiver.

10. The method of claim 8 wherein said first joint means comprises a universal socket joint connectively attached to said first end of said rigid member and connecting said first end of said rigid member to said rail.

11. The method of claim 8 wherein said first joint means comprises a heim joint connectively attached to said first end of said rigid member and connecting said first end of said rigid member to said rail.

12. The method of claim 8 wherein said second joint means comprises a U-shaped receiver having a straight pin hinge, wherein said U-shaped receiver is operable to be connected to said axle, and wherein the second end of said rigid member comprises said straight-pin hinge positioned within said U-shaped receiver.

13. The method of claim 8, wherein said second joint means comprises a universal socket joint operable to be connected to said axle, and connecting said second end of said rigid member to said axle.

14. The method of claim 8 wherein said second joint means comprises a heim joint operable to be connected to said axle, and connecting said second end of said rigid member to said axle.

15. The device of claim 1, wherein said first joint means is a structure comprising at least one of the following: direct welding, bolting, U-joint, universal socket joint, heim joint, or any combination thereof.

16. The device of claim 1, wherein said second joint means is a structure comprising at least one of the following: direct welding, bolting, U-joint, universal socket joint, heim joint, or any combination thereof.

17. The device of claim 1 or 16, wherein said second joint means additionally comprises a saddle shaped connection brace.

18. The device of claim 5, wherein said U-shaped receiver additionally comprises a saddle shaped connection brace.

19. The device of claim 6 wherein said universal socket joint additionally comprises a saddle shaped connection brace.

20. The device of claim 7 wherein said heim joint additionally comprises a saddle shaped connection brace.

21. The method of claim 8, wherein said first joint means is a structure comprising at least one of the following: U-joint, universal socket joint, heim joint, or any combination thereof.

22. The method of claim 8, wherein said second joint means is a structure comprising at least one of the following: U-joint, universal socket joint, heim joint, or any combination thereof.

23. The method of claim 8 or 22, wherein said second joint means additionally comprises a saddle-shaped connection brace and wherein the method further comprises connecting said second joint means to said axle by said saddle-shaped connection brace.

24. The method of claim 12, wherein said U-shaped receiver additionally comprises a saddle-shaped connection brace and wherein the method further comprises connecting said U-shaped receiver to said axle by said saddle-shaped connection brace.

25. The method of claim 13 wherein said universal socket joint additionally comprises a saddle-shaped connection brace and wherein the method further comprises connecting said universal socket joint to said axle by said saddle-shaped connection brace.

26. The method of claim 14 wherein said heim joint additionally comprises a saddle-shaped connection brace and wherein the method further comprises connecting said universal heim joint to said axle by said saddle-shaped connection brace.
